(19) United States
(12) Patent Application Publication
(10) Pub. No.: US 2001/0012335 A1
(43) Pub. Date: Aug. 9, 2001

(54) PREFERENCE BASED TELECOMMUNICATION INFORMATION SERVICE

(76) Inventors: LANCE KAUFMAN, PARADISE VALLEY, AZ (US); JASON KAUFMAN, PARADISE VALLEY, AZ (US)

Correspondence Address: DONALD J LENKSZUS, OCONNOR CAVANAGH ANDERSON, KILLINGSWORTH & BESHEARS, ONE EAST CAMELBACK ROAD SUITE 1100, PHOENIX, AZ, 850121656

(21) Appl. No.: 09/020,328

(22) Filed: Feb. 6, 1998

(51) Int. Cl. H04M 1/64; H04M 3/42

(52) U.S. Cl. 379/67.1; 379/88.01; 379/201.01

(57) ABSTRACT

A method of providing custom audio information to telephone users is described. The information is provided from a preselected information categories and is made available to the user during the time that the user is placed on hold during a telephone connection.

### FIELD OF THE INVENTION

This invention pertains to telecommunications systems, in general, and to telecommunications systems which include holding of calls, in particular.

### BACKGROUND OF THE INVENTION

Years ago, telephone systems began being offered with so called “music on hold” features. These features were initially provided so that callers placed on-hold could determine that the call was still connected but that the call was on hold. Prior to this feature being made available, it was sometimes difficult to determine whether a telephone call was still connected but merely on hold or whether the call was disconnected. Telephone systems presently available have various on-hold options for users which provide the on-hold customer with various information. For example, some systems provide prerecorded information which is determined by the subscriber which placed the call on hold. Often, such information although considered informative by the business which has placed a party on hold is considered to be a nuisance, or a waste of time by the on-hold party. In systems that provide “music on hold” the on-hold party has no choice as to what music will be heard. The “music on hold” may be specific recorded music, or it may be a broadcast station which is connected to the “music on hold” feature of the telephone system used.

All of these prior systems are configured to please the owner of the system placing calls on-hold. Party placed in the on-hold status does not have any option to determine the content of information provided during this time period. In addition, all parties placed on hold by a particular subscriber system will at any given instant in time all receive the same on-hold information. Typically, the party on-hold has no ability to determine the information received.

Typically, people spend five percent of their time on hold during an average person-to-business telephone conversation. On hold percentages for some industries and services, if improperly managed, can reach over fifty percent of the total connect time. It has been said that executives can spend up to one week per year on hold. It is a common occurrence for a business caller to be told “please wait”, “it will be just a minute” and the ultimate imposition of “please hold”. The on hold time is typically filled with silence or meaningless, random information, music or advertising of the other party's choice. Invariably the information is irritating and nonproductive, for it is something unexpected, not requested or not desired by the recipient.

### SUMMARY OF THE INVENTION

In accordance with the principles of the invention, personalized information is provided to a telephone user during periods of being placed on hold. The personalized information is tailored to each individual's interests. The information categories are preselected from selected menus of information. Information from the preselected categories is delivered when the telephone user is placed on hold. The information is transferred to the telephone user through a telecommunication system. The user is thereby provided information meaningful to the user but while engaged in the inevitable on hold activity. In accordance with the principles of the invention, a subscriber based information system provides custom audio information to parties placed on hold in telephone calls. In accordance with the concept of the invention, the telephone user placed on hold hears information provided from the categories which he or she has pre-selected.

### BRIEF DESCRIPTION OF THE DRAWING

The invention will be better understood from a reading of the following detailed description taken in conjunction with the drawing figures in which like reference designators are used to designate like elements, and in which:

FIG. 1 is a flow diagram of operation of a system in accordance with the principles of the invention in which a subscriber to the system services is placed on hold;

FIG. 2 is a flow diagram of operation of a system in accordance with the principles of the invention in which the non subscriber of the system is placed on hold;

FIG. 3 is a detailed flow diagram of operation of a system in accordance with the invention;

FIG. 4 is a detailed flow diagram of operation of a system in accordance with the principles of the invention;

FIG. 5 is a detailed flow diagram of operation of a system in accordance with the principles of the invention illustrating the client server operation; and

FIG. 6 is a functional diagram of a system in accordance with the principles of the invention;

### DETAILED DESCRIPTION

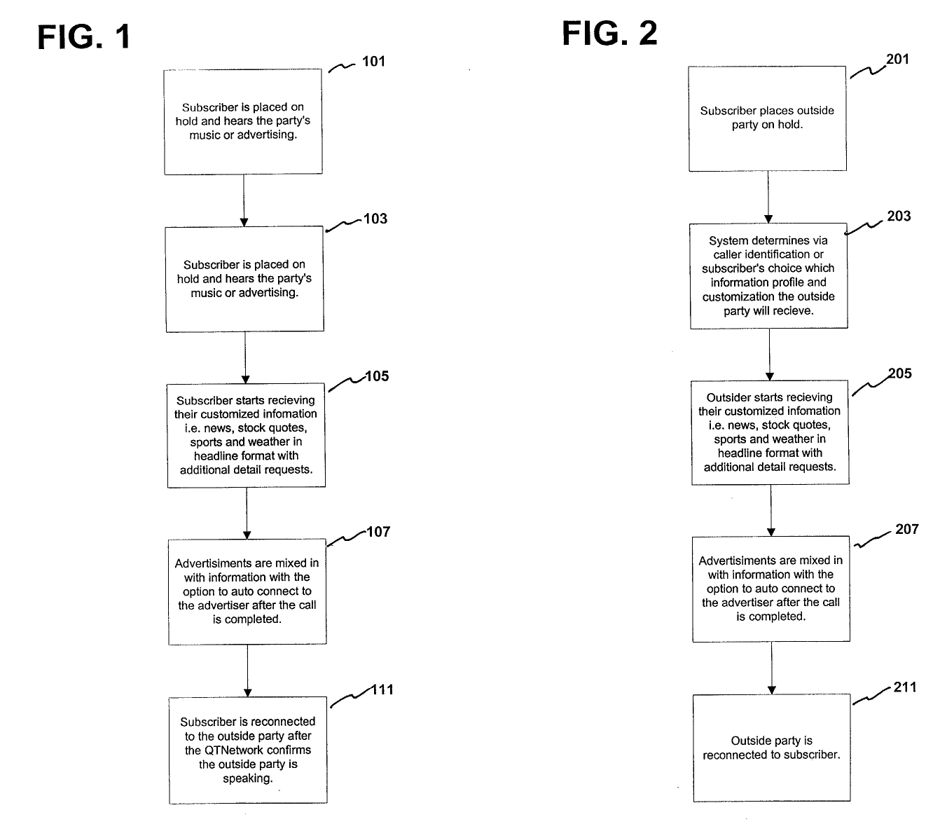

In a system in accordance with the invention, a first party (referred to as the “on-hold party”) is connected to a second party (referred to as the “holder party”) and is placed on hold by the holder party at some point in the conversation. It will be understood by those skilled in the art that the holder party may be either the calling party or the called party and conversely the on-hold party may be either the called party or the calling party. In this instance the on-hold party is a subscriber to the on-hold services in accordance with the invention. Operation of the system is described in conjunction with the flow chart of FIG. 1. After being placed on hold, as indicated at Step 101, the on-hold party S hear the holder party O's selected music or advertising. The on-hold party S can immediately activate a system in accordance with the invention by various methods to override the on hold system of the holder party as indicated in step 103. In the illustrative embodiment of the invention, the on-hold party S activates the system by providing an activation command. The command may be provided by speaking a command, depressing the “#” (pound) key on the telephone keypad or through use of system artificial intelligence. This immediately parks the other end of the call.

While a party is on hold, the system plays for the on-hold party information in custom preselected information categories previously selected by the on-hold party S in a headline type format with interspersed advertisements as indicated in steps 105 and 107. By way of example, the on-hold party S having selected a sports venue might hear: “On ESPN tonight, at seven, Dallas versus the Giants will play on channel twenty six. In sports news, the Green Bay Packers signed Terry Bradshaw as a new assistant coach.” To receive additional information a standard voice command is used such as: “tell me more about Terry” Then the story continues, “In a surprise move, the Green Bay Packers signed Terry Bradshaw and he had this to say ‘I just wanted to be on a winning team’” The system finishes the sports category and starts the next subject preselected by the subscriber and starts the next preselected category. “Merrill Lynch now offers twenty-five dollar commissions on one thousand shares traded. Stock news: Compaq is at seventy five dollars- unchanged; IBM reached one hundred dollars, up two; and Intel is stable at eighty eight dollars”. If the on-hold party S wants to talk to a specific advertiser, a voice command will auto connect the subscriber to the advertiser. The system in accordance with the invention keeps all of the usage information and adds it to the user profile to determine future relevant advertisements to play.

The holder party O takes the call off hold. System tools which may include speech recognition determine if the holder party is back via standard voice commands from the holder party such as “hello” or “are you there” and other electronic sensing systems. This allows the call to be un-parked and reconnected as indicated in Step 111.

In addition to the on hold features, the headlines and advertisements can be played while a subscriber S is not in the on-hold state. This provides the service provider as well as the advertisers with additional broadcast time. The system further includes an off-hold search feature in which advertisements that have the search term selected by the on-hold party. Thus step 309 may be accessed whether or not the subscriber S is on hold. Subscriber S may access the system of the invention by providing an appropriate command to the system 1 by providing a voice command by saying “Quiescent”. System 1 may then access the customized data that he has preselected at step 317 or the subscriber S may initiate a search or access a feature provided from a group of search data bases or features. For example, the subscriber S of the system might say “list all advertisements containing Hugo Boss.” The network searches for all matches. In this instance, the network executes a search of all advertisements that have “HUGO BOSS” in the advertisement's key words. The network then plays for the subscriber a list containing the results of the search such as “Bloomingdales, Nordstroms and Macy's”. If desired, the on hold party is then automatically connected to the advertiser or to a retailer such as a local store which carries the advertised product or supplies the advertised service. Alternatively, the subscriber S may access other features such as requesting additional details on headline information that has been received or access a email or fax information.

The system in accordance with the invention can also operate where a subscriber S to the system services places a non-subscriber O on hold. A flow chart illustrating this process is shown in FIG. 2. At Step 201 the subscriber S to the service places the other party O on hold. The system automatically functions when the subscriber S places a call on hold. The system utilizes caller identification information to determine the identification of the on-hold party. The system can match that information against a data base to determine which preselected information category should be used to transmit information to the on-hold party as indicated at Step 203. The caller identification system includes the public ANI (automatic number identification), public or private DNIS (dialed number identification service), SIS (speech identification systems) or PIN (personal identification number) system depending upon what caller information is available. The on-hold party then starts receiving the customized information in headline format as indicated in Step 205 with interspersed advertisements as indicated in Step 207. For example, “Citibank can reduce your monthly house payments, find out how by asking for the mortgage department. Certificates of deposit have new high rates of 7% at Citibank.” If the on-hold party needs additional information from the advertiser, the on-hold party can use voice commands and auto-connect to the advertiser after the call is completed. In this example, the telephone number of the individual receiving the information is identified as a homeowner having a significant savings account. Specific subject headlines were chosen by rules established within the data base associated with the bank. The system in accordance with the network keeps all of the usage information and adds it to the user profile to better determine what headlines and advertisements to play in the future. When the holder party returns the on-hold party is reconnected and the conversation between may continue as indicated at Step 211.

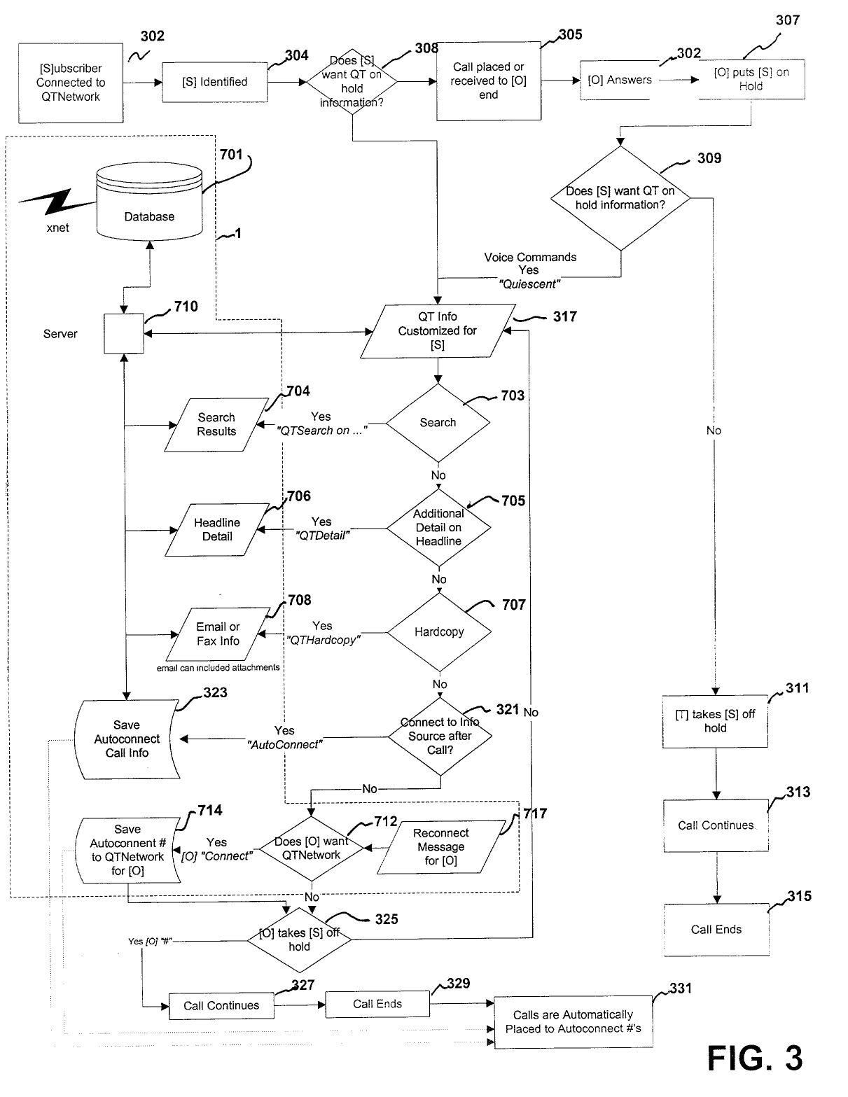

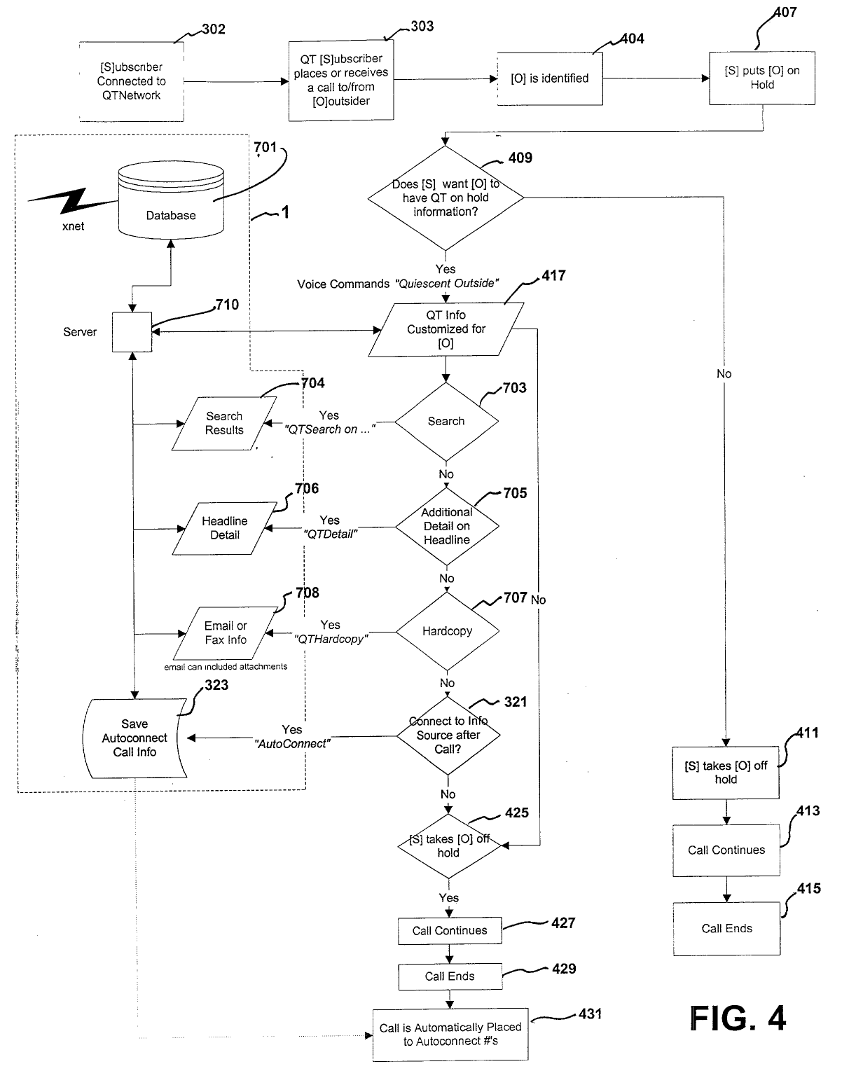

Turning now to FIG. 3, further details of the operation of a system 1 in accordance with the invention are shown in flow chart form. Party S accesses the system 1 at Step 302. The identity of party S is determined by system 1 at step 304. At Step 308 party S can decide whether to directly access the services of system 1 or to proceed with a telephone call. If party S desires to directly access the service of System 1 the operation proceeds to Step 317. If however, party S desires to proceed with a telephone call, the subscriber S places or receives a call at Step 305. At step 306 party O answers the incoming call. At Step 307 party O places party S on hold. Party S can activate system 1 in accordance with the invention or not at decision Step 309. If party S decides to not activate system hold party S will remain on hold with whatever information is provided by the holder party's system until the holder party O takes the on-hold party S off hold at Step 311. Whereupon the call between the parties O and S continues as indicated at Step 313 until the call is terminated at 315. If however the on-hold party S desires to activate system 1 in accordance with the invention, on-hold party S does so as indicated at Step 317. With party S on hold, system 1 provides customized information to the on-hold party S. System 1 includes a data base 701 from which the customized information is accessed. The customized information is played in a headline format with advertisement information included. The on-hold party S may select from several features available from system 1. The features shown as being available in the illustrative embodiment of FIG. 4 include requesting a search for specific information as indicated at step 703, or additional details for headline information heard as indicated at Step 705, or request that electronic text delivery of information be provided such as via email or facsimile as indicated at Step 707, or that a telephone connection be made to an information source such as an advertiser as indicated at Step 321. To access one of the features party S utilizes commands. In the illustrative embodiment the commands are spoken and speech recognition is utilized to respond to the commands. Alternatively, the commands may be entered as a series of keystrokes on the telephone keypad. As shown in FIG. 4, the spoken commands are “QT search” to activate the search feature of Step 703, “QT detail” to activate the detail feature of Step 705, “QT hardcopy” to activate the feature of Step 707, and “Auto connect” to activate the connection feature of Step 321. In response to one of the commands, system 1 will respond to initiate a search and provide search results to party S at step 704 or provide headline details at step 706 or send electronic text as indicated at step 708. In all instances system 1 utilizes a server 710 to access data base 701 to provide the information. The on-hold party S can indicate that he or she desires to be connected to an information source such as an advertiser as indicated at Step 321, whereupon system 1 saves the advertiser's call information at Step 323. When the holder party O takes the on-hold party S off hold at step 325, party O must press a button such as “#” on the telephone to re-connect with the on-hold party S. Prior to being reconnected to party S, system 1 provides an audio message to party O at Step 717 which, for example, may provide information regarding subscription to the service provided by system 1 and a solicitation for such subscription as indicated at Step 712. If party O indicates that he or she has an interest in subscribing, system 1 will save information relative to party O for automatically reconnecting to party O upon completion of the present telephone call as indicated at Step 714. If party O decides to not subscribe or accept the solicitation the call is continued with the connection to party S at Step 327 until the call is terminated as indicated at Step 329. After termination of the call, a new call is automatically placed between party S and the information source identified at Steps 321 and 323. This new call is automatically accomplished by system 1 as indicated at Step 331. In addition, system 1 establishes a call for party O at Step 331 if party O indicated that he or she was interested in the solicitation of Step 712.

Turning now to FIG. 4, operation of system 1 is explained again in detail where the subscriber S to system 1 in accordance with the network is connected with the outside party O and places the outside party O on hold. Access to the system 1 may be by either one of two approaches. Subscriber party S may in fact dial the local system switch which provides the services in accordance with the invention. Alternatively the features of the present invention can be supplied in conjunction with the existing telecommunications equipment. At Step 409 party S can decide whether party O is to receive audio information from network 1 or to proceed with a telephone call. If party S desires that party O be connected to System 1 the operation proceeds to Step 417. If party S decides to not activate system 1 for party O, party O will remain on hold with whatever information if any is provided apart from that provided by the present system until the holder party S takes the party O off hold at Step 411. Following party S taking party O off hold, the call between the parties O and S continues as indicated at Step 413 until the call is terminated at Step 415. If however the party S desires to activate system 1 for party O in accordance with the invention, party S does so as indicated at Step 417. Party S may activate system 1 by the appropriate command which is in this instance the spoken command “Quiescent Outside”. S may select the profile to be utilized or, alternatively, system 1 will utilize ANI or its equivalent or voice recognition to select the profile for the on hold party O as indicated at Step 410. System 1 would then play information selected from customized categories in a headline format for the on hold party. The profile may be selected for the customized information by the subscriber S. The information is presented to the on hold party O in an interactive format and is customized from the profile selected either by the subscribing party S or the other party O as described below. The headlines are interspersed with advertisements.

With party O on hold, system 1 provides customized information to the on-hold party O. System 1 includes a data base 701 from which the customized information is accessed. The customized information is played in a headline format with advertisement information included. Party O may select from several features available from system 1 which party S has preselected. The features shown as being available in the illustrative embodiment of FIG. 4 include requesting a search for specific information as indicated at step 703, or additional details for headline information heard as indicated at Step 705, or request that electronic text delivery of information be provided such as via email or facsimile as indicated at Step 707, or that a telephone connection be made to an information source such as an advertiser as indicated at Step 321. To access one of the features party S utilizes commands. In the illustrative embodiment the commands are spoken and speech recognition is utilized to respond to the commands. Alternatively, the commands may be entered as a series of keystrokes on the telephone keypad. As shown in FIG. 4 the spoken commands are “QT search” to activate the search feature of Step 703, “QT detail” to activate the detail feature of Step 705, “QT hardcopy” to activate the feature of Step 707, and “Auto connect” to activate the connection feature of Step 321. In response to one of the commands, system 1 will respond to initiate a search and provide search results to party S at step 704 or provide headline details at step 706 or send electronic text as indicated at step 708. In all instances system 1 utilizes a server 710 to access data base 701 to provide the information. The on-hold party O can indicate that he or she desires to be connected to an information source such as an advertiser as indicated at Step 321, whereupon system 1 saves the advertiser's call information at Step 323. When party S takes party O off hold at step 425, party S must press a button such as “#” on the telephone to re-connect with party O. The call continues as indicated at Step 427 until the call is terminated as indicated at Step 429. After termination of the call, a new call is automatically placed between party O and the information source identified at Steps 321 and 323. This new call is automatically accomplished by system 1 as indicated at Step 431.

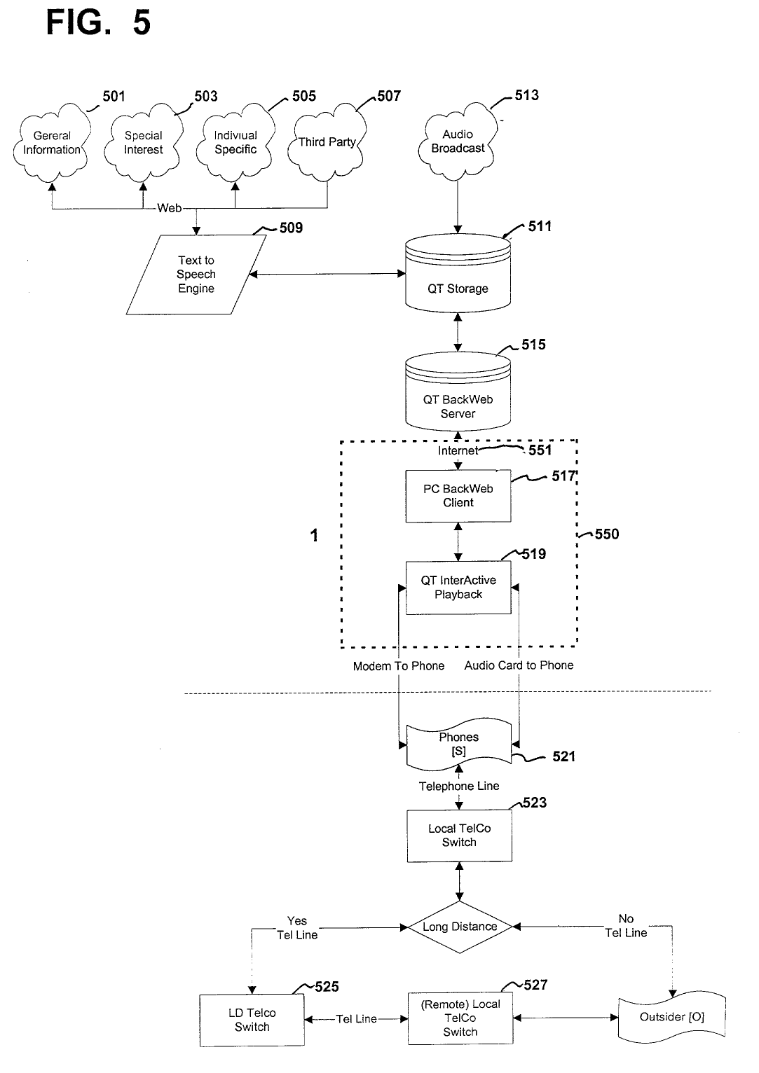

Turning to FIG. 5, one embodiment with system 1 in accordance with the invention is shown on block form. Several sources of information are accessed via the Internet. The information is in the illustrative embodiment of four types of content. The first category is a general interest category 501 includes such information as news, financial sports weather and life style information. The second category 503 includes special interest news. A third category 505 includes individual specific news providing topics such as stock quotes, company news, horoscope, team news and local weather with a maximum number of topics being selectable. The fourth group 507 is third party news which is developed by companies for internal usage, rebroadcast on the system 1 or for outsider on hold applications. One example of third party news would be a real estate brokerage playing listings with the listing s being selected according to a predetermined profile for the outsider. A text to speech engine 509 is utilized to convert the digital information received via the Internet for storage in a system storage medium 511. In addition, various audio broadcast sources 513 may be accessed from a variety of sources such as sources accessible via the world-wide web as well as other sources of digital audio including digital audio stored in system 1 storage 511. The information which is of a general nature, such as news and advertisements is stored on a server 515 and is updated on a substantially continuous basis. It should be noted that the various information sources may be accessed for a particular subscriber only at the time the subscriber logs onto system 1. A subscriber accesses system 1 via his standard phone 521, which may in fact be a computer telephone terminal. When the subscribers telephone 521, and it is not in use, a system 1 automatically dials a client server 550 via an Internet connection 551. The system 550 by utilizing the pre-select customization stored in memory 517 accesses the preselected information from the back web server 515. The information received is stored for use by the subscriber S. The information is periodically updated. When the subscriber picks up the telephone 521, updating of the memory 517 is suspended. The subscriber S utilizing his telephone may access another party in the conventional manner utilizing his local telephone company switch 523 accessing another party or receiving a call from another party O via a long-distance connection 525 and 527, or directly. For subscriber S to activate the on hold feature of the invention, subscriber S uses either voice or keypad command as described herein above. If system 1 is operated such that subscriber S is placed on hold, subscriber S may access advertisers and additional advertising information after the call is completed. If subscriber S places the other party O on hold, the profile of the other party O will be automatically accessed from system 1 to select services for playing to the other party O.

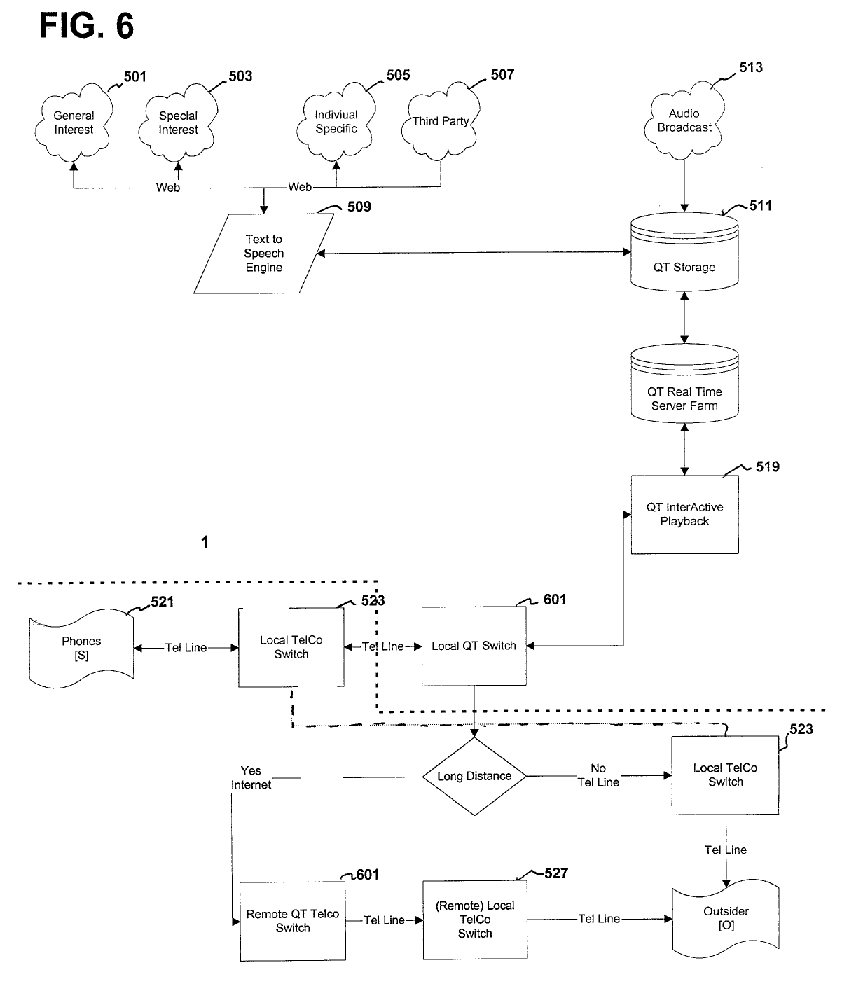

Turning now to FIG. 6, a variation of the invention is shown in which a separate switching arrangement 601 is included in system 1 to provide access to the services in accordance with the invention. Operation of system 1 shown in FIG. 6 is substantially identical to that of system 1 shown in FIG. 5 except that a subscriber S receives a dial tone from system 1 switch 601 to place a call to a desired party O. Customized information that is specific to the subscriber S is requested from system 1 at the time of the subscriber S initially logging onto system 1. Information is processed through the network and stored in the memory 511 as described as FIG. 5. After subscriber S has logged onto system 1, system 1 may be activated via voice or keypad commands as described above. If a desired service is in a mode where the subscriber is not on hold, but desires to access the information, subscriber S may do so by transmitting the appropriate command. Still further in accordance with the invention, system 1 switch 601 may access a connection to the other party O via the most cost-effective carrier, including long-distance telephone service via the Internet 611 and a remote system switch 601.

As will be understood by those skilled in the art, various changes and modifications may be made to the embodiments of the invention which are shown and described without departing from the spirit or scope of the invention. It is not intended to in any way limit the scope of the invention by the illustrative embodiments shown and described. It is intended that the invention be limited in scope only by the claims appended hereto.

What is claimed is:

1. A method for operating a telecommunications system, comprising the steps of:
preselecting portions of audio information from predetermined categories of audio information;
automatically updating said preselected portions at predetermined intervals;
establishing a telecommunication connection between a first party and a second party;
placing said first party on-hold; and
providing said preselected portions of audio information to said first party during substantially the time said first party is on-hold.

2. A method in accordance with claim 1, comprising:
providing said preselected portions of audio information in a headline format.

3. A method in accordance with claim 2, comprising:
interspersing audio advertising information between at least some of said selected portions of audio information.

4. A method in accordance with claim 3, comprising:
responding to signals from said first party to access detailed advertising information.

5. A method in accordance with claim 4, wherein:
said detailed advertising information is accessed after termination of said call between said first and said second parties.

6. A method in accordance with claim 3, comprising:
responding to signals from said first party to access detailed advertising information while said first party is on-hold.

7. A method in accordance with claim 2, comprising:
responding to signals from said first party to access detailed audio information for audio playback in response to signals from said first party.

8. A method in accordance with claim 7, wherein:
said detailed audio information is played to said first party during the time said first party is on-hold.

9. A method in accordance with claim 7, wherein:
said detailed audio information is played to said first party after completion of said telecommunication connection between said first and said second parties.

10. A method in accordance with claim 1, comprising:
terminating said providing step when said first party is no longer on-hold.

11. A method in accordance with claim 1, comprising:
said first party preselecting said portions of audio information.

12. A method in accordance with claim 1, comprising:
said second party selecting said preselected portions of audio information.

13. A method in accordance with claim 1, comprising:
responding to requests from said first party for accessing preselected services.

14. A method in accordance with claim 13, comprising;
responding to audio requests from said first party to access said preselected services.
